(19) United States
(12) Patent Application Publication
(10) Pub. No.: US 2004/0215569 A1
(43) Pub. Date: Oct. 28, 2004

(54) Method to ensure a unique machine serial number

(75) Inventors: Salim Ahmed Agha, Rochester, MN (US); Daniel Charles Birkestrand, Rochester, MN (US); Stephen Mark Igel, Rochester, MN (US); David Otto Lewis, Rochester, MN (US)

Correspondence Address: IBM CORPORATION, ROCHESTER IP LAW DEPT. 917, 3605 HIGHWAY 52 NORTH, ROCHESTER, MN, 55901-7829, US

(73) Assignee: International Business Machines Corporation, Armonk, NY

(21) Appl. No.: 10/422,663

(22) Filed: Apr. 24, 2003

(51) Int. Cl. G06F 17/60

(52) U.S. Cl. 705/57

(57) ABSTRACT

Method, apparatus and article of manufacture for ensuring the uniqueness and non-alterability of vital product data (VPD) of computerized apparatus. To protect the vital product data from undesired alterations, the data is stored in a secure, write-protected location. A copy (or copies) of the VPD may also be stored elsewhere to facilitate recovery in the event the primary copy is lost, corrupted or invalid.

### CROSS-RELATED APPLICATIONS

The present application is related to U.S. patent application Ser. No. 10/366,847 (attorney docket number ROC920020188US1), entitled “METHOD AND APPARATUS FOR FORMATTING VITAL COMPONENT DATA IN A FIELD REPLACEABLE UNIT OF A COMPUTER SYSTEM”, which is herein incorporated by reference in its entirety.

### BACKGROUND OF THE INVENTION

1. Field of the Invention

The present invention generally relates to computerized apparatus and more particularly to ensuring a unique identifier for a computerized apparatus.

2. Description of the Related Art

In the computer industry it is well known to associate vital product data with computers. Vital product data may include, for example, a serial number and a type number. Such vital product data may be provided for a computer system as a whole (referred to as system vital product data), as well as for the individual components of the system. Individual components may include, for example, processors, memory, I/O adapters and the like. The system vital product data (i.e., the vital product data for a computer system as a whole) is typically located on a label secured to an external surface of the computer system, in order to be visibly identifiable. The system vital product data is also typically located in one or more machine-readable storage areas of the computer.

System vital product data may serve various specific purposes, but one purpose is to uniquely identify computer systems from one another. A unique identifier is often needed to ensure compliance with licensing requirements for software, for example. That is, the customer may be required to register the vital product data of each machine on which a licensed software product is installed. Each installation may require in network connection whereby the software provider is given the vital product data of the machine on which the software is to be installed. In this way, the software provider can register the installation and determine whether the customer has purchased a license for the installation by comparing the number of licenses purchased and the number of copies installed.

Another particular purpose of vital product data is enablement of services. One such service is Capacity on Demand available from International Business Machines, Inc. Capacity on Demand is a function available on selected machines whereby the customer can select resources (such as processors and storage) on a permanent or temporary basis. Enabling the function requires the user to input, among other things, the serial number of the machine on which capacity is being requested.

It should be evident that the success of using vital product data according to the foregoing purposes is dependent upon the vital product data being unique. Without means for ensuring the uniqueness of vital product data users may subvert licensing and service agreements by reusing the same vital product data on multiple machines.

Consider, for example, the use of unique system serial numbers, which are created for machines at the time of manufacture. The system serial number is a kind of vital product data widely relied upon by vendors to identify machines in licensing and service agreements. When certain hardware is changed due to failure or an upgrade, a new system serial number may be re-entered by a user through a user interface. Without a uniqueness enforcement policy in place, the user may input the old system serial number rather than the appropriate new system serial number corresponding to the new hardware. As a result, this process can lead to duplicate serial numbers thereby allowing a user to violate licensing and/or service agreements without being detected by providers.

One attempt to ensure uniqueness of vital product data is to enforce a “system password” within the operating system, which is required in order to operate the machine. The system password is tied to various component identification numbers of a machine (such as the machine serial number and a processor card serial number), each of which is represented as stored data in a secure computer-readable memory area. The system password is derived from the various components so that if any one of the components changes (due to hardware failures or upgrades) the system password also necessarily changes. Since the algorithm by which the system password is derived is unknown to the user, the user must contact a provider (e.g. manufacturer) to get the new system password in order to operate the machine. By controlling the system password, the provider effectively ensures uniqueness of the vital product data of the machine.

However, a disadvantage of using a system password is the extra steps that must be taken by the operating system, customer, service provider and manufacturer to detect hardware or serial number changes, and create and enforce system password validation.

Therefore, there is a need for ensuring the uniqueness and non-alterability of vital product data of computerized apparatus.

### SUMMARY OF THE INVENTION

The present invention generally pertains to ensuring the uniqueness and non-alterability of vital product data of computerized apparatus.

In one aspect, a method for ensuring the validity of vital product data of a computer is provided. The method includes initiating an initial program load (IPL) of the computer; during the IPL, determining validity of a write-protected copy of vital product data identifying the computerized apparatus; and completing the IPL only if the validity of the write-protected copy is determined.

Another aspect provides a method for providing system vital product data of a computer. The method includes providing a first machine-readable medium configured to store a write-protected master copy of the system vital product data; and providing a second machine-readable medium configured to store a backup copy of the system vital product data, wherein the backup copy is copied to the first machine-readable medium as the master copy in case of an absence of the master copy at initial program load of the computer.

Another aspect provides a method for ensuring the validity of vital product data identifying a computer. The method includes providing a first machine-readable medium configured to store a write-protected master copy of the vital product data; providing a second machine-readable medium configured to store a backup copy of the vital product data; initiating an initial program load (IPL) of the computer; during the IPL, determining a state of the write-protected master copy and a state of the backup copy; and performing processing dependent on the states of the master copy and the backup copy.

Yet another aspect provides a method for ensuring the validity of vital product data identifying a computer. The method includes providing a first machine-readable medium configured to store a write-protected master copy of the vital product data; providing a plurality of second machine-readable mediums each configured to store a backup copy of the vital product data; initiating an initial program load (IPL) of the computer; during the IPL, determining a state of the write-protected master copy and a state of each backup copy; and performing processing dependent on the states of the master copy and the backup copy.

Yet another aspect provides a computer including a first machine-readable medium configured to store a write-protected master copy of the vital product data; a second machine-readable medium configured to store a backup copy of the vital product data; and a memory containing instructions which, when executed, are configured to at least: determine a state of the write-protected master copy and a state of the backup copy during initial program load; and perform processing dependent on the states of the master copy and the backup copy, the processing comprising at least completing the initial program load only if the state of the master copy is valid.

Still another aspect provides a method for protecting an on-demand resource on a computerized apparatus. The method includes initiating an initial program load (IPL) of the computerized apparatus; during the IPL, determining a presence of a valid copy of vital product data identifying the computerized apparatus, wherein the valid copy is located on a secure write protected medium; completing the IPL only if the presence of the valid copy is determined; and after completion of the IPL, processing a request to enable the on-demand resource which results in a fee being incurred by a requester of the on-demand resource.

Still another aspect provides a method for enabling resources on a computerized apparatus. The method provides initiating an initial program load (IPL) of the computerized apparatus; during the IPL, determining a presence of a valid copy of vital product data identifying the computerized apparatus, wherein the valid copy is located on a secure write protected medium; receiving an enablement code; verifying the enablement code with respect to the vital product data; and in response to verifying the enablement code, enabling a quantity of the resources.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a block diagram of a data processing system having a vital product data identifying data processing system, the vital product data being stored in at least one write-protected storage area.

FIG. 2 is a representative block diagram illustrating one possible architecture of an environment for storing and validating vital product data of a computer.

FIG. 3 is a flow chart illustrating embodiments for reading and validating vital product data.

FIG. 4 is a state diagram illustrating possible states of a master copy of vital product data and a backup copy of vital product data.

FIG. 5 is a block diagram of an environment having a provider of enablement codes providing such codes to users (e.g., customers).

FIG. 6 is a block diagram of a computerized apparatus having resources capable of being enabled for use according to a resource-time value.

FIG. 7 is a flow chart illustrating the operation of one embodiment of the invention implemented in the context of a provider and customers of the provider.

### DETAILED DESCRIPTION OF THE PREFERRED EMBODIMENTS

The present invention generally pertains to ensuring the uniqueness and non-alterability of vital product data (VPD) of computerized apparatus. To protect the vital product data from undesired alterations, the data is stored in a secure, write-protected location. A copy (or copies) of the VPD may also be stored elsewhere to facilitate recovery in the event the primary copy is lost, corrupted or invalid. Thus, it is contemplated to have a master copy (trusted copy) of the vital product data in a primary location and a backup copy in a secondary location (or multiple backup copies in multiple secondary locations). In one embodiment, the master copy is copied to the secondary location(s) at every initial program load (i.e., system boot) wherein any backup copy(s) resident at the secondary location(s) is different than the master copy. Alternatively, the validated master copy may indiscriminately be copied to the secondary location(s) without first determining whether a backup copy(s) at the secondary location(s) is different from the master copy.

One embodiment of the invention is implemented as a program product for use with a computer system. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

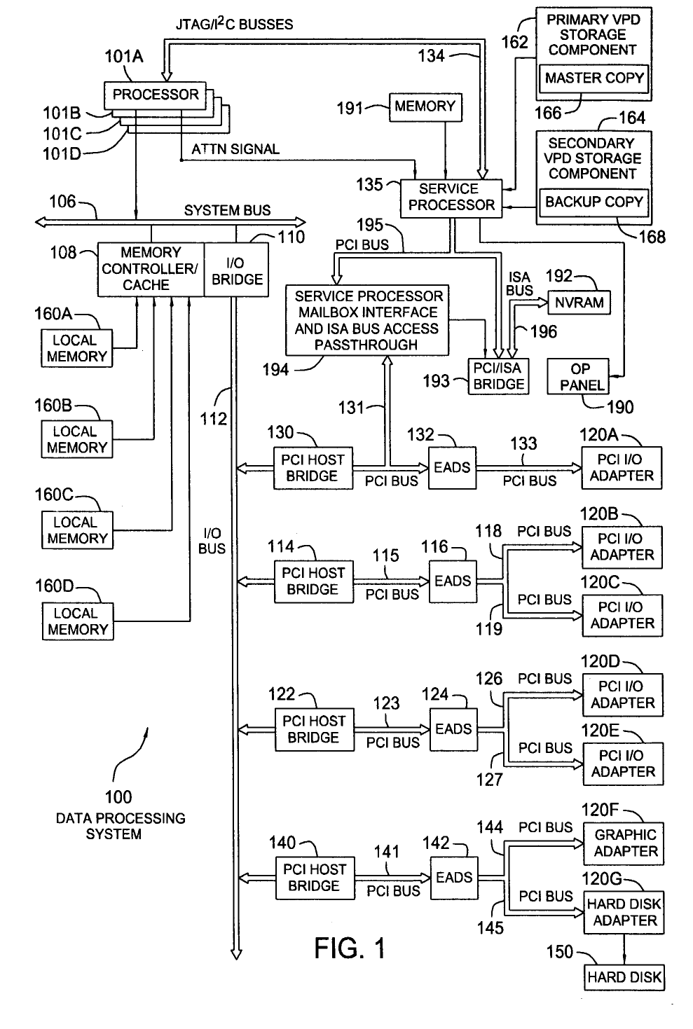

FIG. 1 shows a data processing system 100 that becomes a special-purpose computer according to an embodiment of the invention when configured with the features and functionality described herein. A particular computer which may be used to advantage is the eServer iSeries computer available from International Business Machines, Inc. More generally, however, the data processing system 100 may represent any type of computer, computer system or other programmable electronic device having at least one processing unit, including a client computer, a server computer, a portable computer, a personal digital assistant (PDA), an embedded controller, a PC-based server, a minicomputer, a midrange computer, a mainframe computer, and other computers adapted to support the methods, apparatus, and articles of manufacture of the invention. The data processing system 100 may be a standalone device or part of a network (e.g., a local area network or a wide area network). In this regard, the invention may be practiced in a distributed computing environment in which tasks are performed by remote processing devices that are linked through a communications network. In a distributed computing environment, program modules may be located in both local and remote memory storage devices. In any case, it is understood that FIG. 1 is merely one configuration for a computer and computer system. Embodiments of the invention can apply to any comparable configuration, regardless of whether the data processing system 100 is a complicated multi-user apparatus, a single-user workstation, or a network appliance that does not have non-volatile storage of its own.

Illustratively, data processing system 100 is a symmetric multiprocessor (SMP) system including a plurality of processors 101A-D connected to a system bus 106. Illustratively, the processors are PowerPC® processors available from International Business Machines Corporation of Armonk, New York. Although shown as a SMP system, a single processor system may alternatively be employed. Also connected to the system bus 106 is memory controller/cache 108, which provides an interface to a plurality of local memories 160A-D. The local memories 160A-D may be any memory sufficiently large to hold various programs and data structures. The local memories 160A-D could be one or a combination of memory devices, including Random Access Memory, nonvolatile or backup memory, (e.g., programmable or Flash memories, read-only memories, etc.). In addition, the local memories 160A-D may be considered to include or represent memory physically located elsewhere in the data processing system 100, for example, any storage capacity used as virtual memory or stored on a mass storage device (e.g., a direct access storage device) or on another computer coupled to the data processing system 100.

I/O bus bridge 110 is connected to the system bus 106 and provides an interface to I/O bus 112. Memory controller/cache 108 and I/O bus bridge 110 may be integrated as depicted.

The data processing system 100 is a Peripheral Component Interconnect (PCI) bus implementation which supports a plurality of Input/Output adapters. Typical PCI bus implementations will support between four and eight I/O adapters (i.e. expansion slots for add-in connectors). Illustratively, the processing system 100 includes seven (7) I/O adapters 120A-G. Each I/O Adapter 120A-G provides an interface between data processing system 100 and input/output devices such as, for example, other network computers, which are clients to data processing system 100. By way of example, a PCI Host bridge 114 connected to I/O bus 112 provides an interface to PCI local bus 115. A number (two shown) of I/O adapters 120B-C may be connected to PCI bus 115 via EADS 116 and respective PCI buses 118 and 119. Other I/O adapters may be similarly connected by respective PCI host bridges (e.g., bridges 122, 130 and 140), EADS (e.g., EADS 124, 132, and 142) and PCI buses (e.g., 123, 126-127, 131, 133, 141 and 144-145). It is noted that EADS is a PCI multifunction device that contains multiple PCI-PCI bridge devices as individual functions of the EADS device. Each PCI-PCI bridge device connects to a PCI adapter slot or an adapter chip embedded with EADS on a PCI bus backplane. In one embodiment, each EADS PCI-PCI bridge includes logic that provides logical partition error and DMA isolation, so that errors and DMA requests associated with a particular slot affect only the partition that owns that slot, and no others sharing the same PHB (to other slots).

As examples of particular types of adapters, the system 100 includes a memory mapped graphics adapter 120F, which may be connected to I/O bus 112 through the PCI Host Bridge 140 and EADS 142 via PCI buses 141 and 144 as depicted. Also, a hard disk 150 may be connected to I/O bus 112 through PCI Host Bridge 140 and EADS 142 via PCI buses 141 and 145, and a hard disk adaptor 120G as depicted.

The PCI host bridge 130 provides an interface for a PCI bus 131 to connect to I/O bus 112. PCI bus 131 connects PCI host bridge 130 to the service processor mailbox interface and ISA bus access passthrough logic 194 and EADS 132. The ISA bus access passthrough logic 194 forwards PCI accesses destined to the PCI/ISA bridge 193, which also connects to NV-RAM storage 192 via an ISA bus 196. A service processor 135 is coupled to the service processor mailbox interface 194 through its local PCI bus 195. In one embodiment, the service processor 135 may contain a programmable processor (not shown) and a resident memory for executing a control program, and is thus itself a small computer within a larger computer. The service processor 135 is generally a special-purpose functional unit that does not execute user application programs, as do processors 101A-D, but is configured to carry out low-level functions such as initializing the system, maintenance, and performance of monitoring functions, such as checking for, and reporting, errors in the data processing system 100. In one embodiment, the service processor 135 performs a VPD discovery and validation function described below. To this end, the service processor 135 is connected to the primary and secondary VPD storage components 162, 164. It is noted, however, that this arrangement is merely illustrative and that embodiments without a service processor are also contemplated.

The service processor 135 is also connected to processors 101A-D via a plurality of JTAG/I²C buses 134. JTAG/I²C buses 134 are a combination of JTAG/scan busses (see IEEE 1149.1) and Phillips I²C buses. However, alternatively, JTAG/I²C buses 134 may be replaced by only Phillips I²C busses or only JTAG/scan busses. All SP-ATTN signals of the host processors 101A-D are connected together to an interrupt input signal of the service processor 135, where the interrupt signal is the ATTN Signal line. The service processor 135 has its own local memory 191, and has access to the hardware op-panel 190.

When data processing system 100 is initially powered up, service processor 135 uses the JTAG/scan buses 134 to interrogate the system (Host) processors 101A-D, memory controller 108, and I/O bridge 110. At completion of this step, service processor 135 has an inventory and topology understanding of data processing system 100. Service processor 135 also executes Built-In-Self-Tests (BISTs), Basic Assurance Tests (BATs), and memory tests on all elements found by interrogating the system processors 101A-D, memory controller 108, and I/O bridge 110. Any error information for failures detected during the BISTs, BATs, and memory tests are gathered and reported by service processor 135.

If a meaningful/valid configuration of system resources is still possible after taking out the elements found to be faulty during the BISTs, BATs, and memory tests, then a vital product data (VPD) validation process is performed before allowing the system 100 to initial program load (IPL), also known as “booting” the system. In one embodiment, the VPD validation process is carried out by the service processor 135 executing instructions embodied in firmware residing in the NVRAM. In one embodiment, the VPD validation process is performed with respect to vital product data discovered during the interrogation of components that was described above. The VPD validation process (including discovery of VPD) will be described in more detail below. Ultimately, the service processor 135 releases the Host processors 101A-D for execution of the operating system code loaded into Host memory 160A-D.

In one embodiment, the data processing system 100 is logically partitioned. A logical partition is logical separation of resources on a system, where each separate group of resources is under the control of a separate operating system. Each of these multiple operating systems may have any number of software programs executing within in it. When logically partitioned, different hardware resources, such as processors 101A-D, memories 160A-D, and I/O adapters 120A-G may be assigned to different logical partitions. A partition manager is then provided for managing the logical partitions. In a particular embodiment, the partition manager is implemented as a “Hypervisor”, a software component available from International Business Machines, Inc. of Armonk, New York.

For example, suppose data processing system 100 is divided into three logical partitions, P1, P2, and P3 where each partition has a different operating system assigned to it. Thus, one instance of the Advanced Interactive Executive (AIX) operating system may be executing within partition P1, a second instance (image) of the AIX operating system may be executing within partition P2, and a LINUX operating system may be operating within logical partition P3.

Each operating system executing within data processing system 100 may access only those I/O units that are within its logical partition. Thus, each of I/O adapters 120A-G, each of the processors 101A-D, each of the local memories 160A-D is assigned to one of the three partitions. For example, processor 101A, memory 160A, and I/O adapters 120B, 120D, and 120E may be assigned to logical partition P1; processors 102B-C, memory 160B, and I/O adapters 120C and 120A may be assigned to partition P2; and processor 101D, memories 162C-D, and I/O adapters 120F-G may be assigned to logical partition P3. Alternatively, the logical partitions may define one or more logical/virtual resources, such as processors. A virtual processor, for example, corresponds to processing capability provided by one or more physical processors. Where virtual processors are implemented, the logical partitions do not have exclusive ownership over specific physical processors. Rather, the physical processors may be shared amongst the various logical partitions, and are available to the logical partitions according to the virtual processors defined for the respective logical partitions.

It should be noted, that even singular resources may be shared. For example, the system 100 may be a single processor system, in which the single processor is a shared resource between multiple logical partitions. In such a hardware environment, each logical partition “owns” a fractional portion of the processor.

Regardless of the configuration, those of ordinary skill in the art will appreciate that the system depicted in FIG. 1 is merely illustrative and may vary. For example, other peripheral devices, such as optical disk drives and the like, also may be used in addition to, or in place of, the hardware depicted. Further, and as noted above, a system configured with a designated service processor is not a necessary element to the present invention. Accordingly, the depicted example is not meant to imply architectural limitations with respect to the present invention.

To implement the VPD validation, the data processing system 100 is configured with at least one or more primary vital product data (VPD) storage component 162. In one embodiment, the data processing system 100 is also configured with on one or more secondary VPD storage components 164. Although the use of multiple (redundant) primary and secondary VPD storage components is contemplated, some aspects of the invention will be described with reference to a single primary and single secondary VPD location for convenience. In any case, the primary VPD storage component 162 provides a storage location for a master copy 166 of the system VPD for the data processing system 100, while the secondary VPD storage component 164 (if present) provides a storage location for a backup copy 168 of the system VPD.

In one embodiment, the VPD storage components 162, 164 are any secure, tamper-proof and removable machine-readable components configured to contain vital product data for the data processing system 100. In a particular embodiment, the VPD storage components 162, 164 comprise removable smart chips, or smart chips on a “field replaceable component”, or FRU. A FRU is a component made up of two or more physically connected components and designed to be physically replaceable with an equivalent component after manufacture of the system. That is, a component is coupled to other components in the system using electrical connectors, clips, threaded fasteners, and the like, which are designed for coupling and uncoupling after manufacture. A finished electronic circuit board assembly, complete with all components soldered in place, is often designed as such a FRU, while an integrated circuit chip typically is not. A particular example of a FRU is a processor card having one or more processors (e.g., processors 101) disposed thereon. However, a FRU need not be a card assembly, and could alternatively be a component such as a disk drive storage device, a terminal, a power supply, and so forth.

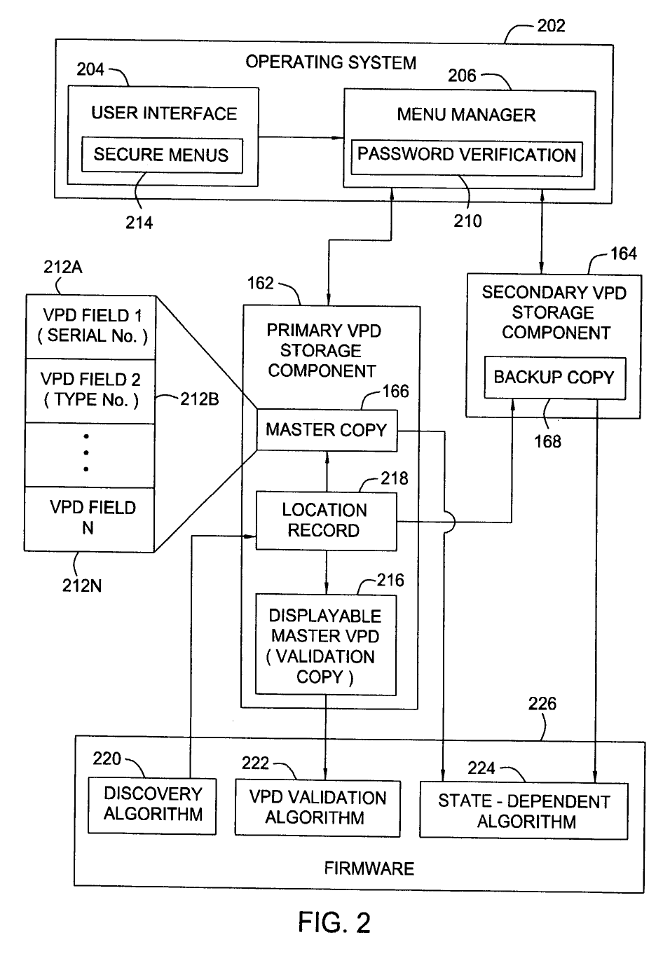

It is currently known to store FRU VPD (i.e., vital product data relating to a particular FRU) within a non-volatile storage area onboard the FRU itself, as is described in U.S. patent application Ser. No. 10/366,847 (attorney docket number ROC920020188US1), entitled “METHOD AND APPARATUS FOR FORMATTING VITAL COMPONENT DATA IN A FIELD REPLACEABLE UNIT OF A COMPUTER SYSTEM”, herein incorporated by reference in its entirety. Such FRU VPD may be used by various system functions for purposes of verifying component compatibility, configuring low-level operating system functions, isolating system faults, and so forth. Accordingly, in one embodiment, the system VPD of the present invention may be stored in the same storage area with the FRU VPD. For example, the secondary VPD storage component 164 may be a processor card having a smart chip which contains the backup copy 168 of the system VPD as well as the FRU VPD specific to the processor card. In contrast, the primary VPD storage component 162 is preferably a stand-alone FRU containing the master copy 166 of the system VPD. Additional information which may be contained in the primary and secondary storage components 162, 164 will be described in more detail below respect to FIG. 2.

FIG. 2 shows illustrative software components resident on the data processing system 100. For purposes of the present invention, the “software” of FIG. 2 may include firmware resident, for example, in the NV-RAM 192 shown in FIG. 1. In general, FIG. 2 shows a user interface 204 to a VPD menu manager 206. The user interface 204 and menu manager 206 may be configured to allow a user to write vital product data to the master copy 166. Once the system VPD is written to the master copy 166, the master copy 166 is write protected to prevent subsequent writes thereto. In one embodiment, the master copy 166 is write-protected by the provision of encryption keys. Particular examples of encryption technology that may be used include checksums, Digital Signature Standard (Federal Information Processing Standard 186-2), Eliptic Curve Crypto systems (ECC) and Data Encryption Standard-Method Authentication Code (DES-MAC) and any other technology, known or unknown. In this way, only users having access to the appropriate decryption algorithm may “unlock” the master copy 166. As an additional level of security, it is contemplated that a user's ability to write to the master copy 166 may be restricted using a secure menu(s) 214 (available via the user interface 204) requiring a system password verified by a password verification algorithm 210. Alternatively, the secure menu 214 may be accessible to any user with a limited range of functionality. For example, all users may be allowed to view the contents of the master copy 166, while only authorized users (i.e., those having logged in with an appropriate password) have the ability to modify the contents. In yet another embodiment, users may only view a displayable master VPD record 216, i.e., an instance of the master copy 166 capable of being displayed via the user interface 204. In this case, the master copy 166 itself is hidden, e.g., no directory path to the master copy 166 is provided. In one aspect, the displayable master VPD record 216 is also used to validate the master copy 166 and is therefore also referred to herein as a “validation copy 216”. It is noted that in one embodiment, the validation copy 216 and the backup copy 168 are also write-protected by the provision of encryption keys.

Illustratively, the vital product data contained in the master copy 166, backup copy 168 and the displayable master VPD record 216 (collectively, “the VPD records”) comprises one or more identifiers corresponding to the data processing system 100 and/or components of the data processing system 100. Accordingly, the VPD records may each include one or more fields 212A, 212B, . . . 212N configured to hold such identifiers (for simplicity only illustrative fields for the master copy 166 are shown). In a particular embodiment, the VPD records include only a machine serial number field 212A written with the serial number for the data processing system 100. However, the vital product data stored in the VPD records 166, 168 and 216 may also include any other identifier or combination of identifiers such as a type number, brand number, and system number for the data processing system 100. Regardless of quantity, each field of at least the master copy 166 is protected. That is, the fields 212 may not be written to by users, except by those having logged in via the secure menu 214 using the appropriate password, and then only if the fields are blank (e.g., all fields of the copy are ASCII blanks or possibly Hexadecimal 0's). After being written to, the fields of the master copy 166 are write protected as described above. The data in the fields of the master copy are then copied to the validation copy 216, which may then also be write protected. In some cases, the master copy data is also copied to the backup copy 168, as will be described in more detail below. It is noted that in one embodiment, the data processing system 100 may be placed in a manufacturing mode in which the backup copy 168 can be written, if not blank, to facilitate certain manufacturing processes where parts are moved between machines during testing. In contrast, the master copy 166 cannot be written more than once (except by users privy to the encryption algorithm).

In one embodiment, the location of the master copy 166, the backup copy 168 and displayable master VPD record 216 (including the location of any redundant copies) is given by a location record 218. Illustratively, the location record 218 is resident on the primary VPD storage component 162. However, the location record 218 may also be resident elsewhere. In operation, the location record 218 is accessed by a discovery algorithm 220 resident in firmware 226. The firmware 226 also includes a VPD validation algorithm 222 configured to validate the system VPD discovered by the discovery algorithm 220. In addition, the firmware 226 includes a state-dependent algorithm 224 invoked after execution of the validation of the system VPD.

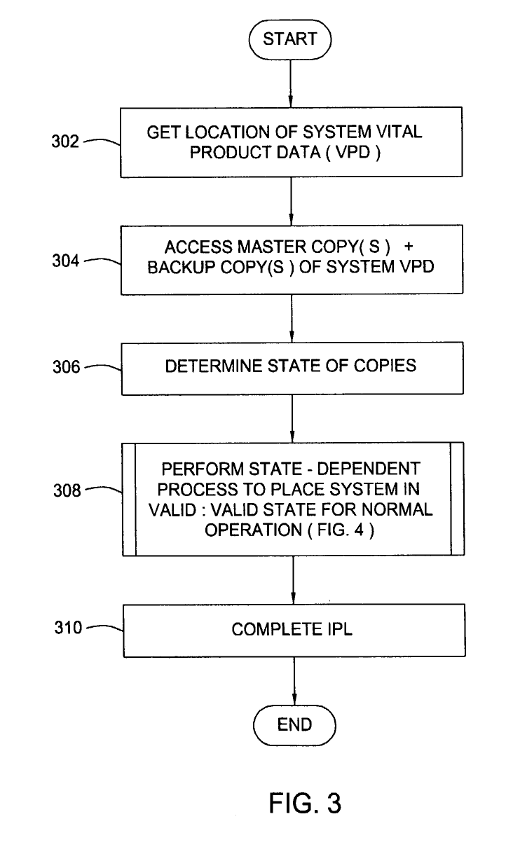

One embodiment of the operations implemented by the algorithms of the firmware 226 is described FIG. 3. In one embodiment the operations of FIG. 3 are carried out by the service processor 135 shown in FIG. 1. However, the operations could be performed by other system components, and the data processing system 100 need not necessarily have a dedicated service processor.

Upon initiating an IPL, the discovery algorithm 220 is executed to determine the location of at least the master copy 166 and the backup copy 168 of system VPD using the location record 218 (step 302). It is noted that while the location record 218 may explicitly indicate the addresses of the VPD records, the location record 218 may also take advantage of a hierarchical arrangement of components within the data processing system 100. For example, it was noted above that FRUs may contain their own VPD in an associated memory area. This FRU VPD may contain pointers to one or more dependent FRUs, which may themselves contain pointers to one or more other dependent FRUs and so on. In this case, the pointers collectively form a tree structure which may be traversed from each parent to the various children. Accordingly, the location record 218 need only specify the location of each parent. Discovery of the various children can then be accomplished by traversing the tree structure. In one embodiment, this discovery process is performed by the discovery algorithm 220 invoked at an early stage of system start-up and prior to allowing the IPL of the data processing system 100. In particular, the discovery algorithm 220 is hard coded with the address of the location record 218.

Having discovered at least location of the master copy 166 and the backup copy 168 (assuming such copies are present on the system), the respective copies are accessed to retrieve the VPD contained therein (step 304). The VPD validation algorithm 222 then determines the state of the VPD of each copy (step 306). In one embodiment, the state may be blank, error or valid. A blank state indicates a functional copy (i.e., capable of being successfully read), but containing no written vital product data (e.g., all fields of the copy are ASCII blanks or Hexadecimal 0's). An error state indicates one of an unreadable copy, an invalid copy, the absence of any copy or a mismatched backup (i.e., a backup copy that does not match the master copy). In the context of an error, it is understood that the error may be caused by the copy itself or by the medium on which the copy resides (i.e., the corresponding storage component 162, 164), such as where the medium is not present or is damaged. A valid state indicates a copy which has been determined to match the validation copy 216.

After determining the state of each copy, the state-dependent processing is performed (by the state-dependent algorithm 224) to place the system in a valid state for normal operation and ensure uniqueness of vital product data, such as the serial number, for the data processing system 100. It is noted that the state-dependent algorithm 224 may rely on input from an operator, such as where replacement of the one or more of the storage components 162,164 is necessary.

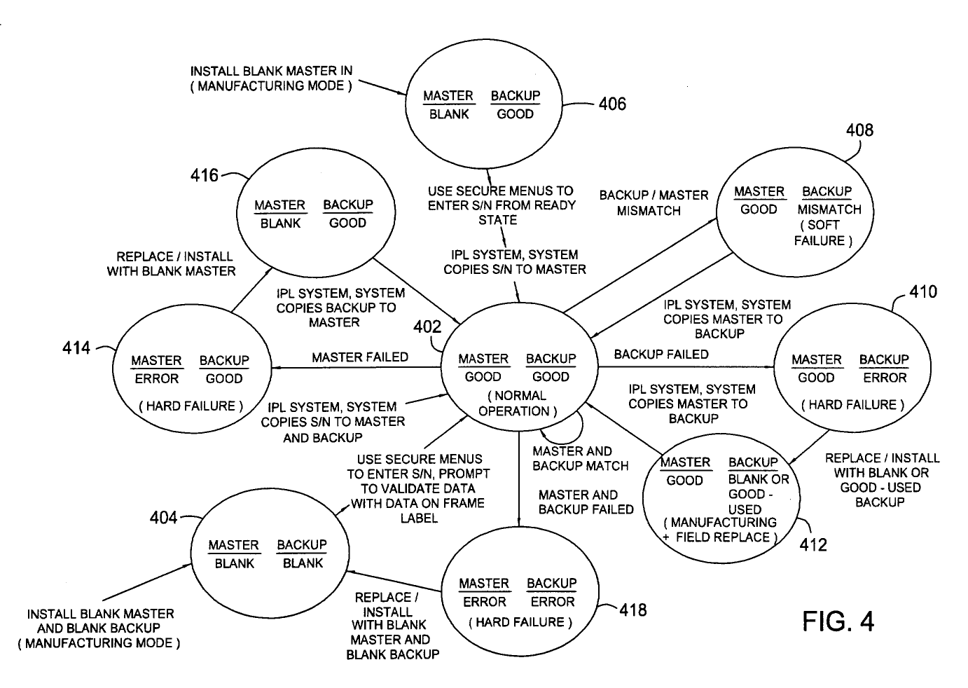

One embodiment of the processing implemented by the state-dependent algorithm 224 is shown in FIG. 4. In particular, FIG. 4 is state diagram illustrating the various permutations of the combined individual copy states of the master copy 166 and the backup copy 168. Each permutation is referred to herein as a “system state”. Normal operation is characterized by a valid:valid system state 402; that is, both the master copy 166 and the backup copy 168 are in a valid state. Prior to normal operation (e.g., during manufacturing), the data processing system may be first placed in a blank:blank state 404 when a blank master copy and a blank backup copy are installed. The data processing system may then be powered up in a special mode (i.e., a manufacturing mode) in which an authorized user may enter an appropriate password and use the secure menus 214 to input the vital product data for the computer. In one embodiment, the user is then prompted to validate the input VPD with respect to the data on a frame label affixed to the computer. If the input is validated, the VPD is written to the master copy 166 as well as the displayable master VPD record 216. When the system next IPL's, the contents of the master copy 166 are copied to the backup copy 168, thereby placing the system in the valid:valid system state.

In a particular embodiment, it is contemplated that the manufacturing mode may be entered after installing a blank master copy in a system containing a valid backup copy, in which case the system is in a blank:valid system state 406. However, manufacturing processes (e.g., build and test) typically result in components which affect the serial number (e.g., processor cards) being moved, thereby resulting in the invalidation of the serial number in the backup copy. As a result, an authorized user may enter and validate the VPD for the system, thereby causing the VPD to be written to the backup copy. When the system next IPL's, the contents of the backup copy are copied to the master copy, thereby placing the system in the valid:valid system state.

From normal operation (i.e., the valid:valid system state 402), the system may experience a soft failure or a hard failure. A soft failure is one from which the system can recover and is characterized by a master/backup mismatch. That is, the VPD contained in the backup copy does not match the validated VPD in the master copy, resulting in a valid:mismatch state 408. In order to return the system to normal operation (i.e., the valid:valid state 402), the system is IPL'ed, during which the VPD contained in the master copy is copied to the backup copy.

In contrast, a hard failure is one from which the system cannot recover. A hard failure is characterized by (i) the need to remove at least one corrupted storage component 162, 164 (e.g., the data on the component is unreadable or is invalid); or (ii) the absence of at least one of the storage components. In either case, installment of a storage component is required in order to correct the failure. For simplicity of description, scenarios will be described in which an existing storage component fails and must be replaced. It is understood, however, that the remedial process used to address failures caused by the absence of a storage component is substantially the same, except that initial removal of a failing storage component is not required.

In one scenario, a hard failure is caused by the failure of an existing secondary storage component 164 on which the backup copy 168 resides, resulting in a valid:error system state 410. The hard failure is corrected by first removing the failing secondary storage component and then installing a blank replacement storage component, thereby placing the system in a valid:blank state 412. When the system is next IPL'ed, the contents of the valid master copy are copied to the backup copy residing on the replacement storage component. The system is then in a valid:valid state 402. It is noted that the replacement storage component may alternatively be a used component containing written data, rather than being blank. In this case, the system is in the valid:mismatch state 408 and the contents of the replacement component are overwritten at the next IPL.

In another scenario, a hard failure is caused by the failure of an existing primary storage component 162 on which the master copy 166 resides, resulting in an error:valid system state 414. The hard failure is corrected by first removing the failing primary storage component and then installing a blank replacement storage component, thereby placing the system in a blank:valid state 416. When the system is next IPL'ed, the contents of the validated backup copy are copied to the master copy residing on the replacement storage component. The system is then in a valid:valid state 402.

In another scenario, a hard failure is caused by the failure of both the existing primary storage component 162 and the secondary storage component 164. The hard failure may be corrected by replacing both failing components with blank replacements, thereby placing the system in a blank:blank state 404. The remaining steps to place the system in the valid:valid state 402 have been described above.

The state diagram of FIG. 4 illustrates that a valid master copy of the system vital product data must exist before the data processing system is allowed to IPL. Further, at every IPL in which the master copy is determined to be different than the backup copy (valid:mismatch state), the valid master copy is copied into the backup copy, if the backup copy are different than the master copy. In an alternative embodiment, the state of the backup copy is not determined at every IPL. Instead, the master copy is indiscriminately copied to the backup copy, if the master copy can be successfully validated.

Other system states not described by FIG. 4 are also contemplated. For example, it was noted above that some embodiments include multiple master copies 166 and/or multiple backup copies 168. For purposes of illustration, consider a system having a single master copy and a plurality of backup copies. At every IPL, the contents of the master copy are copied into each of the backup copies for any backup copy having contents different from the master copy. This process substantially conforms to the correction of the soft failure system state 408 described above for the single master/backup scenario. If, however, the master copy is blank (such as when the primary storage component has been replaced following a hard failure), then all backup copies must be matching and valid before the system will use them to copy the backup VPD to the master copy. If all backup copies do not match, those copies with invalid VPD must be removed. When only those backup copies containing valid VPD remain, the VPD is written to the master copy. Only then is the system allowed to IPL.

On Demand Resources

In one embodiment, the VPD (e.g., serial number) of a computer is used to support access to on-demand resources computerized resources. Computerized resources are made available on demand in response to actual needs, rather than projected needs. In one aspect, the provision of such flexibility provides a cost efficient solution to accommodate peaks and valleys that occur in any business. Increased loads for seasonal, period end, or special promotions, for example, can be responded to quickly and efficiently. A customer pays for the capacity/resources that it needs, when it is needed. As a result, the cost of computerized resources substantially matches the computerized resources actually being used, and does not include a substantial premium for excess capacity not being used. Of course, in practice, providers may attach some form of a premium to the flexibility provided by on demand resource access. However, even with such a premium, some users will realize a savings.

It should be noted that while aspects of the invention are described in the context of a business, the invention provides advantages to any user, whether involved in a business or not. Further, aspects of the invention will be described with reference to temporary capacity on demand (also referred to herein as On/Off Capacity on Demand, or On/Off CoD). That is, a quantity of the resources is made available for limited period of time. However, it is understood that the scope of the invention includes any form of providing on-demand resources including permanent capacity on demand. Both temporary capacity on demand and permanent capacity on demand are currently being provided by International Business Machines Inc.

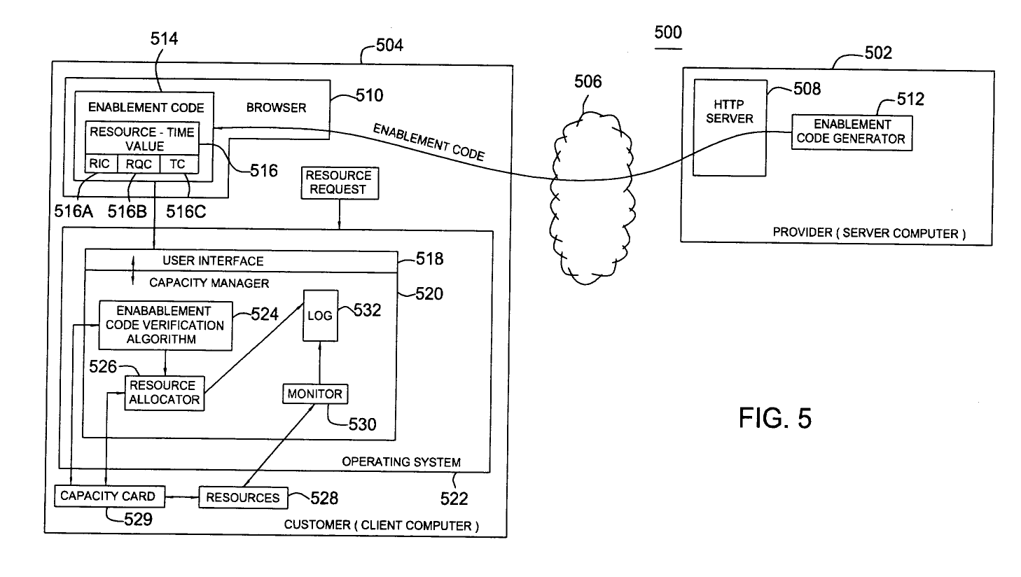

Referring now to FIG. 5, a data processing environment 500 shown. Generally, the environment includes a provider computer 502 and a customer computer 504. The provider computer 502 is illustratively embodied as a server computer with respect to the customer computer 504, which is therefore embodied as a client computer. Although both are shown as singular entities, in practice the provider computer 502 and the client computer 504 may each be a network of computers configured to perform various functions described herein. Therefore, it is understood that although only one client computer is shown, a plurality of client computers may be configured according to aspects of the invention and, in some cases, be serviced by the provider computer 502 and/or the customer computer 504. Further, the terms “client” and “server” are used merely for convenience and not by way of limitation. As such, the customer computer 504, which may be a client relative to the provider computer 502 in some regards, may itself be a server relative to one or more other clients (not shown).

The provider computer 502 and the customer computer 504 communicate through a network 506. Illustratively, the network 506 may be any medium through which information may be transferred such as, for example, a local area network (LAN) and a wide area network (WAN). The network 506 is merely representative of one communications medium. Some aspects of the invention may be facilitated by other communication mediums such as, for example, the U.S. Postal Service. Still other aspects may be practiced in the absence of any communication medium between the provider 502 and the customer 504.

In a particular embodiment, the network 506 is the Internet. As such, the provider computer 502 may be configured with a hypertext transfer protocol (HTTP) server 508 capable of servicing requests from a browser program 510 residing on the customer computer 504. The HTTP server 508 and the browser program 510 provide convenient and well-known software components for establishing a network connection (e.g., a TCP/IP connection) via the network 506, and for receiving information from users on the computer systems 502, 504.

In one embodiment, the provider computer 502 is configured with an enablement code generator 512 (also referred to herein as the code generator 512). The code generator 512 in this embodiment is an algorithm capable of generating an enablement code 514. The code generator 512 may be invoked by a request received from the customer computer 504 via the network 506. In response to a request, the code generator 512 generates the code 514, which may be returned to the customer computer 504 via the same network connection. Alternatively, the code 514 may be returned via a different network connection, e.g., a subsequent network connection or an altogether different network. In a particular embodiment, the enablement code 514 is transmitted electronically to a client mail application (e.g., Lotus Notes® or Microsoft Outlook®; not shown) residing on the customer computer 504. Lotus Notes is a registered trademark of International Business Machines, Inc., and Microsoft Outlook is a registered trademark of Microsoft, Inc. In yet another alternative, the enablement code 514 is provided to the user (e.g., administrator) of the customer computer 504 via paper mail (i.e., the postal service) or facsimile, for example.

Regardless of the particular medium, the enablement code 514 in this embodiment is unique and configured for use only on a particular machine (e.g., the customer computer 504). The code 514 includes a particular value referred to herein as a resource-time value 516. The resource-time value 560 generally provides information capable of identifying a resource and how much of that resources available for use. In one embodiment, the resource-time value 516 generally identifies a resource, a quantity of the resource and a corresponding unit of time. As such, the resource-time value 516 shown in FIG. 5 is configured with a resource-identifying component (“RIC”) 516A, a resource quantity component (“RQC”) 516B and a time component (“TC”) 516B. The resource-identifying component 516A specifies a resource type and resource quantity component 516B specifies a quantity of the resource. The time component 516C may specify a time period for which the resource is enabled. It should be noted that where on-demand capacity is available only for one type of resource, the resource-time value 516 may not require a resource-identifying component 516A. Similarly, where on-demand capacity is available for a unique resource (e.g., a central processing unit in a single processor machine), the resource-time value 516 may not require a resource-quantity component 516B.

As a particular example, a resource-time value 516 specifies a number of processors (in the resource quantity component 516B) and a time period (in the time component 516C) for which the processors may be used. Where the time period is given in days (a day being a 24 hour period), for example, the product of these values is a number of processors-days. Accordingly, “N processors-days” equals N_{P}*N_{D}, where N_{P} is a number of processors and N_{D} is a number of days. More generally, the resource component of a resource-time value may be any resource (e.g., of the customer computer 504) capable of being made selectively available according to request. Such resources include hardware such as, for example, memory and storage. The resource is may also include software, such as applications and databases. Yet another resource capable of being made selectively available is interactive capability (i.e., the number of users permitted access on the system). In addition, the quantity of the resource specified by the enablement code may be a whole number or a fraction. For example, in the case of processors, N_{P} may be an integer value or a fractional value such as 0.25, where 0.25 may be quantified by CPU cycles. Other resources may be similarly quantified.

It is contemplated that the resource-time value 516 need not explicitly include a quantity of resources and a time value. Rather, the resource-time value 516 may include only the resource-identifying component 516A and a unit-less usage limit value. Alternatively, such a usage limit value may be the product of the resource quantity component 516B and the time component 516C. These aspects of the resource-time value 516 will be described more detail below.

The resource-time value 516 may be input to a capacity manager 520 via a user interface 518. Alternatively, the resource-time value 516 is input directly by provider computer 502 via a communication link (e.g., a network or modem connection). In still another embodiment, the resource-time value 516 is input to the capacity manager 520 via an application or some other program or routine.

In one embodiment, the capacity manager 520 is the Capacity on Demand function provided on machines from International Business Machines, Inc. One such machine is the eServer iSeries® computer. By way of illustration only, the capacity manager and user interface 518 are shown as components of an operating system 522. Examples of the operating system 522 include IBM OS/400®, AIX®, UNIX, Microsoft Windows®, and the like. However, the illustrated representation is merely one example of a particular software architecture, and not limiting of the invention. OS/400® and AIX®, are registered trademarks of International Business Machines, Inc., and Microsoft Windows® is a registered trademark of Microsoft, Inc.

In one embodiment, an enablement code verification algorithm 524 is invoked to verify the input enablement code 514. As noted above, the enablement code 514 is preferably specific to a particular machine. Accordingly, the verification algorithm 524 determines whether the enablement code 514 is configured for the particular machine for which the capacity manager 520 has responsibility and controls resource access. In this regard, it is contemplated that the capacity manager 520 may have resource access responsibility for a plurality of computers (i.e., a network). More typically, however, the capacity manager 520 manages only the resources of the machine on which it resides. In this case, the verification algorithm 524 determines whether the enablement code 514 is configured for the particular machine on which the capacity manager 520 resides.

If the enablement code 514 is verified, the capacity manager 520 then enables selected resources 528, e.g., hardware, according to the resource-time value 516. In particular, a resource allocator 526 (a function of the capacity manager 520) is invoked to enable, or “unlock”, the selected resources. Enabling the resources 528 may be implemented by the provision of capacity-on-demand hardware. Illustratively, such hardware is represented as one or more capacity-on-demand cards 529. Each card 529 may be specific to a particular hardware type, e.g., processors, memory, etc. Alternatively, a single card may be used to enable multiple resource types. In one aspect, the capacity-on-demand cards 529 are used to store capacity-on-demand information in a secure (i.e., not accessible by the user) and nonvolatile manner. In one embodiment, the information stored in the capacity-on-demand cards 529 includes resource usage information (which will be described more detail below). As such, the card provides a master copy of such information that may be used to recover from a power failure situation or other catastrophic failure. The cards 529 may also be used to validate enablement codes and, as such, may cooperate with the enablement code verification algorithm 524. In a particular embodiment, the enablement codes are validated with respect to contents of the capacity cards 529 as well the contents of the master copy of the VPD. For example, the system only IPLs if the VPD is valid, and the enablement code(s) saved within the capacity card (or entered and therefore being validated) contain the system serial number and type uniquely identifying the system. The system verifies those values against the valid system VPD copy to make sure they match. If not, the enablement code is rejected, or CoD function enters a protected state if it's an existing saved enablement code.

In one embodiment, “enabling” or “unlocking” resources by the resource allocator 526 operates to place the resources into service (i.e., to perform their designated functions such processing or storing, depending upon the resource). In particular, the resource allocator 526 places a quantity of the resources into service for a period of time, as defined by the respective components of the resource-time value 516 (i.e., the resource-identifying component 516A, the resource quantity component 516B and the time component 516C).

In another embodiment, enabling the resources does not place the resources into service, but merely makes the resources available for request by a user. That is, enabling the resources unlocks the resources so that a user can assign into a task, but does not automatically give control of the resources to the operating system(s) on the computer. In this respect, it is contemplated that the user may be given flexibility in the manner in which the resource-time value 516 is used. For example, the resource-time value may define a usage limit which may be reached by specifying any variety of resource quantity values and time values, so long as the sum of the products of the specified quantity values and time values does not exceed the usage limit. In this regard, the user interface 518 may provide a field for specification of a quantity of resources (e.g., number of processors) and a field for specification of a period of time, where the product of the specified values must be less than or equal to the resource-time value. In this way, multiple resource requests may be made for capacity based on a single enablement code so long as the sum of the products of the specified quantity values and time values is equal to or less than the usage limit value specified by the resource-time value of a particular enablement code. Again, the usage limit value may be an explicit singular value specified in the resource-time value or may be the product of the resource quantity component 516B and time component 516A. As an example, assume that the usage limit specified in a particular enablement code is 16. A first request may specify usage of one processor for eight days, the product of which is eight (1 (processor)*8 (days)=8). At this point, additional resource requests may be made because the total usage value (i.e., 8) is less than the resource-time value of 16. Accordingly, a second request may specify usage of eight processors for one day, the product of which is eight (8 (processors)*1 (days)=8). The sum of the products totals 16 (8 (first request)+8 (second request)=16), which is the value of the resource-time value and, as such, no additional usage for the given enablement code is available for request. The usage value may then be decremented according to usage, but the requestor (e.g., user) is given the flexibility in determining precisely how the usage value will be consumed by assigning appropriate weights to the quantity of resources and the duration of time for which the resources are used.

It should be clear that regardless of the manner in which resources are placed into service, the duration for which the resources are in use (or at least available to be used if needed during continued operation of the system) is predefined according to a specified time limit (e.g., a time limit specified by a user or the time specified by the time component 516B of the resource-time value 516). Once the specified time limit expires, the enabled resources are reclaimed (e.g., by the resource allocator 526), and thereby disabled from further use. Of course, the same resources may again be enabled with another resource-time value 516. Aspects of the reclamation will be described in more detail below.

It is also contemplated that the resource-time value 516 may implicitly be defined for a given number of resource-time units, e.g., for 100 processor-days. In this case, the enablement code 514 need not explicitly include the resource-time value 516. Rather, the resource-time value is predefined on the computerized apparatus. Once the machine-specific enablement code 514 is entered, the computerized apparatus is enabled for the predefined resource-time value. Alternatively, either the resource quantity component 516B or the time component 516C may be defined on the computerized apparatus, and the other component is then provided with the enablement code 514. For example, the computerized apparatus may be configured with a resource quantity value of 5 processors, while an enablement code 514 includes a time component 514C having a value of 100.

Generally, the resources enabled according the enablement code 514 (e.g., as specified by the resource-identifying component 516A of the resource-time value 516) may be any variety of resources in a computerized apparatus. Such apparatus include any type of computer, computer system or other programmable electronic device, including a client computer, a server computer, a portable computer, a personal digital assistant (PDA), an embedded controller, a PC-based server, a minicomputer, a midrange computer, a mainframe computer, and other computers adapted to support the methods, apparatus, and article of manufacture of the invention. A computer may include any electronic device having at least one processor, and may be a standalone device or part of a network.

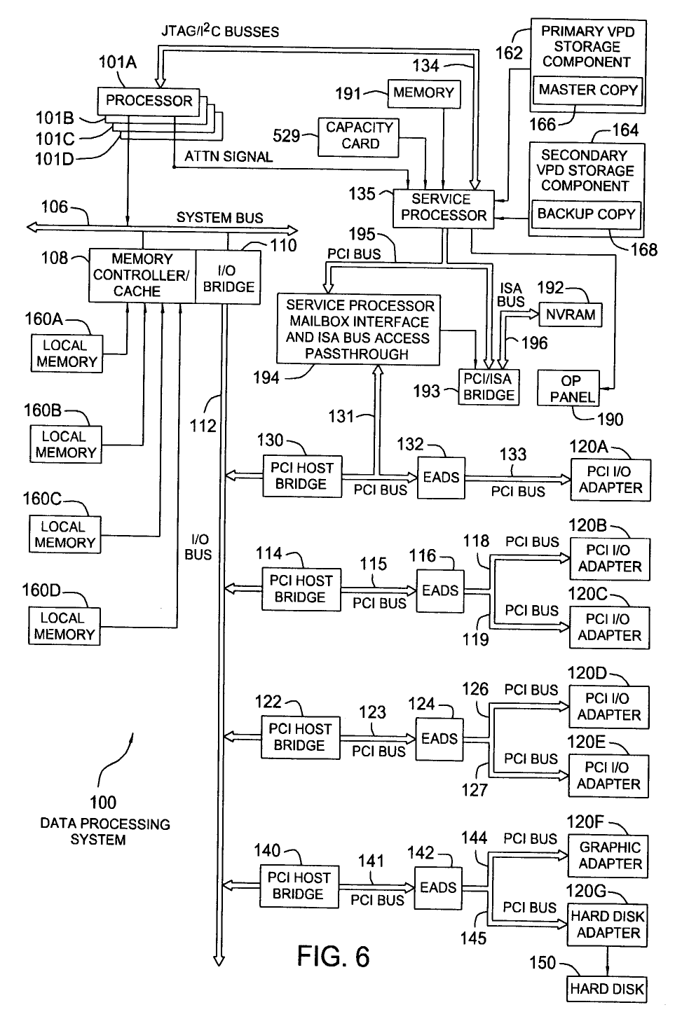

Referring now to FIG. 6, an illustrative data processing system 600 is shown which depicts various resources that may be enabled according the resource-time value 516 of the present invention. Accordingly, the data processing system 600 may be considered one embodiment of the client computer 504. For simplicity, the data processing system 600 is substantially the same as the data processing system 100 shown in FIG. 100 and components previously described are labeled with reference numerals corresponding to FIG. 1 and will not be described again here. Rather, the data processing system 600 is intended merely to shown one embodiment of a system having the capacity card 529 therein. The operation of the data processing system 600 is also substantially the same as that of the data processing system 1. Thus, assuming the master copy of the VPD is validated during IPL, the resource allocator 526 communicates with the capacity card(s) 529 to establish a secure session and determine, for example, the number of resources requested, the history of previous requests for On/Off capacity, the amount of On/Off capacity remaining, etc., before allowing the system 600 to complete the IPL. The data processing system 600 is allowed to proceed to load executable code into local (Host) memories 660A-D according to the determined state.

Operation

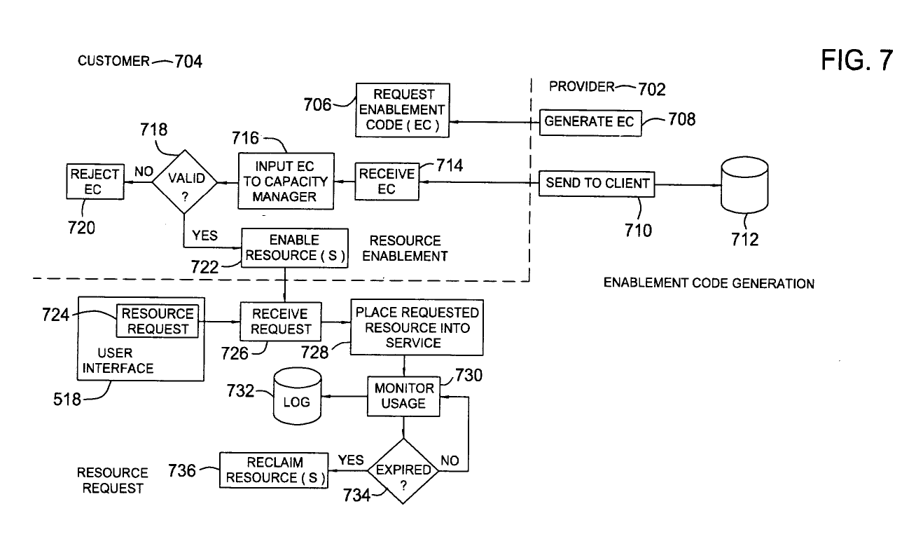

Referring now to FIG. 7, a flow chart is shown illustrating various aspects of operation. In general, the FIG. 7 shows operations performed by provider 702 and a customer 704. In one embodiment, the provider 702 may implement its operations using the provider computer 502 and the customer 704 may implement its operations using the client computer 504, both of which are shown in FIG. 5 and described above. Accordingly, reference will be made to certain aspects of FIG. 5, where appropriate. It is assumed that the client computer 504 has already IPL'ed and that the master copy of the system VPD has been validated in the manner described above.

In one embodiment, a resource enablement service operation is initiated by a customer request (step 706) for an enablement code. In response to the request, the provider 702 generates an enablement code (step 708) and then sends the enablement code to the customer 704 (step 710). For record-keeping purposes, the provider 702 may store the enablement code to a database 712.

Upon receipt of the enablement code (step 714) the customer inputs the code to the capacity manager 520 (step 716). As noted above, inputting the enablement code may be done using the user interface 518. However, is also contemplated that the enablement code may be input to the capacity manager 520 directly by the provider 702 via a communications link (e.g., and network connection). In another embodiment, the enablement code is input by an application or other program or routine. In any case, the capacity manager 520 then determines whether the enablement code is valid (step 718). If the code is invalid (for example, it was generated for another machine), the capacity manager 520 rejects the code (step 720). If the enablement code is valid, the resources specified in the resource identification component of the enablement code are enabled (step 722).

In one embodiment, validation of the enablement code includes matching the system serial number and type embedded in the enablement code with the serial number and type that was validated in the system VPD during IPL. The values must match if the CoD function is to allow the resource enablements. In this regard, precautions are also contemplated in the event of a system VPD or capacity card failure during system runtime (e.g., for some reason the machine is no longer able to communicate with a smart chip). One precaution against possible system tampering is to cause the CoD function to enter a protected state and not allow any further CoD requests to occur until the system VPD or capacity card failure is fixed.

At any time after the selected resources are enabled, a resource request 724 may be received by the capacity manager 520 (step 726). The resource request 724 may be issued by a user via the user interface 518. Alternatively, the resource request 724 may be issued by some other resource of a given system. For example, a software program may determine the need for additional processing power in order to perform a function. If additional enabled processors are standing by, the software program may request the use of these processors.

Regardless of its source, the resource request 724 may specify a quantity of resources to be used and a period of time during which the specified quantity of resources will be used. The resource request 724 may specify all, or a portion of, the enabled resources so long as the usage limit defined by the resource-time value 516 is not exceeded, as described above.

In any case, for a given request, the specified quantity of resources are placed into service for the specified time period (step 728). The capacity manager 520 (and more specifically, the monitor 530) then monitors the usage of the requested resources (step 730). Information pertaining to the usage may be logged in a database 732 (which may include the log 532 described above with reference to FIG. 5) and within the capacity card 529 (also shown in FIG. 5) for non-volatility and security reasons. When the requested time period for the selected resources expires (as determined at step 734), or when the request for the resources is canceled, the resources are reclaimed (step 736).

The reclamation process at step 736 may vary depending upon policies set for the operating system, for example. In some cases, such as where the resources have been configured into a secondary partition in a logically partitioned environment, it may be undesirable to reclaim the resources. In this case, the resources may be marked as “Unreturned” and their continued usage is tracked and billed to the customer. Subsequent attempts to reclaim the resources may then be made periodically. If the operating system is to allow the removal of resources from a running (functional) partition, then the steps taken by the system to reclaim the resource are substantially the opposite of the allocation process. As an example, consider a system needing to reclaim a processor from a partition. If the partition has more than one processor assigned to it, a work scheduler function may attempt to reassign jobs that are running, or are queued up to run, on the processor to be reclaimed to other processors assigned to the partition. The processor may then be reclaimed by changing its state to “inactive”.

While the foregoing is directed to embodiments of the present invention, other and further embodiments of the invention may be devised without departing from the basic scope thereof, and the scope thereof is determined by the claims that follow.

What is claimed is:

1. A method for ensuring the validity of vital product data of a computer, comprising:
initiating an initial program load (IPL) of the computer;
during the IPL, determining validity of a write-protected copy of vital product data identifying the computerized apparatus; and
completing the IPL only if the validity of the write-protected copy is determined.

2. The method of claim 1, wherein the write-protected copy is stored on a smart chip.

3. The method of claim 1, wherein the vital product data comprises a serial number of the computer.

4. The method of claim 1, wherein the vital product data uniquely identifies the computer.

5. The method of claim 1, wherein determining the validity of the write-protected copy of vital product data comprises comparing the write-protected copy to a validation record containing the system vital product data.

6. The method of claim 5, wherein the write-protected copy is a hidden record.

7. A method for providing system vital product data of a computer, comprising:
providing a first machine-readable medium configured to store a write-protected master copy of the system vital product data;
providing a second machine-readable medium configured to store a backup copy of the system vital product data; and
copying the backup copy to the first machine-readable medium as the master copy in case of an absence of the master copy at initial program load of the computer.

8. The method of claim 7, wherein the vital product data comprises a serial number of the computer.

9. The method of claim 7, wherein master copy is copied to the second machine-readable medium as the backup copy under predefined conditions existing at initial program load (IPL) of the computer comprising (i) a mismatch of data between an instance of the backup copy and master copy; and (ii) an absence of the backup copy.

10. The method of claim 7, wherein the vital product data uniquely identifies the computer.

11. The method of claim 7, wherein both the master copy and the backup copy are protected from being written to by unauthorized users.

12. The method of claim 7, wherein at least the first machine-readable medium is a smart chip.

13. The method of claim 7, wherein the first and second machine-readable mediums are field replaceable units each comprising at least one smart chip, the respective smart chips containing the master copy and the backup copy.

14. The method of claim 7, wherein the second machine-readable medium is a processor card comprising at least one smart chip containing the backup copy.

15. The method of claim 7, wherein the master copy is a hidden, non-displayable record, and method further comprising:
providing a validation record containing the system vital product data; and
validating at least the master copy with respect to the validation record.

16. A method for ensuring the validity of vital product data identifying a computer, comprising:
providing a first machine-readable medium configured to store a write-protected master copy of the vital product data;
providing a second machine-readable medium configured to store a backup copy of the vital product data;
initiating an initial program load (IPL) of the computer;
during the IPL, determining a state of the write-protected master copy and a state of the backup copy; and
performing processing dependent on the determined states of the master copy and the backup copy.

17. The method of claim 16, wherein the vital product data comprises a serial number of the computer.

18. The method of claim 16, wherein determining the state of the master copy comprises determining validity of the master copy, and wherein the processing performed comprises completing the IPL only if the validity of the master copy is determined.

19. The method of claim 16, wherein determining the state of the master copy comprises determining an absence of the master copy on the first machine-readable medium and wherein performing processing comprises copying the backup copy to the first machine-readable medium as the master copy.

20. The method of claim 16, wherein determining the state of the backup copy comprises determining an absence of the backup copy on the second machine-readable medium and wherein performing processing comprises copying the master copy to the second machine-readable medium as the backup copy.

21. The method of claim 16, wherein determining the state of the backup copy comprises determining a mismatch between contents of the backup copy and contents of the master copy and wherein performing processing comprises overwriting the contents of the backup copy with the contents of the master copy.

22. A method for ensuring the validity of vital product data identifying a computer, comprising:
providing a first machine-readable medium configured to store a write-protected master copy of the vital product data;
providing a plurality of second machine-readable mediums each configured to store a backup copy of the vital product data;
initiating an initial program load (IPL) of the computer;
during the IPL, determining a state of the write-protected master copy and a state of each backup copy; and
performing processing dependent on the states of the master copy and the backup copy.

23. The method of claim 22, wherein the vital product data comprises a serial number of the computer.

24. The method of claim 22, wherein determining the state of the master copy comprises determining validity of the master copy, and wherein the processing performed comprises completing the IPL only if the validity of the master copy is determined.

25. The method of claim 22, wherein determining the state of the master copy comprises determining an absence of the master copy on the first machine-readable medium; the method further comprising copying the backup copy to the first machine-readable medium as the master copy.

26. The method of claim 22, wherein determining the state of the backup copy comprises determining an absence of the backup copy on the second machine-readable medium and wherein performing processing comprises copying the master copy to the second machine-readable medium as the backup copy.

27. The method of claim 22, determining the state of the master copy comprises determining an absence of the master copy on the first machine-readable medium and wherein determining the state of each backup copy comprises determining a mismatch between at least two of the backup copies and wherein performing processing comprises:
preventing the IPL from completing until the mismatch is eliminated;
if the mismatch is eliminated, copying contents of one of the backup copies to the master copy and then allowing the IPL to complete.

28. A computer, comprising:
a first machine-readable medium configured to store a write-protected master copy of the vital product data;
a second machine-readable medium configured to store a backup copy of the vital product data; and
a memory containing instructions which, when executed, are configured to at least:
determine a state of the write-protected master copy and a state of the backup copy during initial program load; and
perform processing dependent on the states of the master copy and the backup copy, the processing comprising at least completing the initial program load only if the state of the master copy is valid.

29. The computer of claim 28, wherein the vital product data comprises a serial number of the computer.

30. The computer of claim 28, wherein the vital product data uniquely identifies the computer.

31. The computer of claim 28, wherein the master copy is a hidden, non-displayable record.

32. The computer of claim 28, wherein both the master copy and the backup copy are protected from being written to by unauthorized users.

33. The computer of claim 28, wherein at least the first machine-readable medium is a smart chip.

34. The computer of claim 28, wherein the first and second machine-readable mediums are field replaceable units each comprising at least one smart chip, the respective smart chips containing the master copy and the backup copy.

35. The computer of claim 28, wherein the second machine-readable medium is a processor card comprising at least one smart chip containing the backup copy.

36. The computer of claim 28, wherein the instructions are firmware.

37. The computer of claim 28, wherein the instructions are configured to determine whether the state of the master copy is valid by comparing the master copy to a validation copy of the vital product data.

38. The computer of claim 28, wherein the processing performed by the instructions in determining the state of the master copy comprises determining an absence of the master copy on the first machine-readable medium and further comprises copying the backup copy to the first machine-readable medium as the master copy.

39. The computer of claim 28, further comprising:
a plurality of on-demand resources comprising at least one of hardware and software; and
a capacity manager configured to enable at least a portion the plurality of on-demand resources which results in a fee being incurred by a requester of the portion of the on-demand resources.

40. The system of claim 39, wherein the enabled portion of the resources comprises at least one of a processor, storage and memory.

41. The system of claim 39, wherein the capacity manager configured to enable by unlocking the resource and making it available for use upon request.

42. A method for protecting an on-demand resource on a computerized apparatus, comprising:
initiating an initial program load (IPL) of the computerized apparatus;
during the IPL, determining a presence of a valid copy of vital product data identifying the computerized apparatus, wherein the valid copy is located on a secure write protected medium;
completing the IPL only if the presence of the valid copy is determined; and
after completion of the IPL, processing a request to enable the on-demand resource which results in a fee being incurred by a requester of the on-demand resource.

43. The method of claim 42, wherein the vital product data comprises a serial number of the computerized apparatus.

44. The method of claim 42, wherein processing the request to enable the on-demand resource comprises:
receiving a resource-time value comprising a resource-identifying component and a usage limit component, wherein the resource-identifying component specifies a given type of a resource and the usage limit component defines a maximum allowable usage value of the resource; and
enabling a quantity of the resource of the given type specified by the resource-identifying component based on the usage limit component.

45. The method of claim 44, wherein the usage limit component defines the maximum allowable usage value of the resource on the basis of time and quantity.

46. The method of claim 44, wherein the resource-time value specifies the quantity of the resource to be enabled.

47. The method of claim 44, wherein the given type of the resource specified by the resource-identifying component comprises at least one of a processor, a memory and a storage unit.

48. The method of claim 44, wherein the resource-time value is a machine-specific code unique to the computerized apparatus.

49. The method of claim 44, further comprising validating the resource-time value with respect to the vital product data.

50. The method of claim 49, wherein the vital product data is a serial number and type identifier of the computerized apparatus.

51. The method of claim 44, wherein enabling comprises enabling the quantity of the resource of the given type specified by the resource-identifying component for a time period, wherein the quantity and the time period are delimited by the usage limit component.

52. The method of claim 51, wherein a mathematical product of the quantity and the time period must be less than or equal to the maximum allowable usage value.

53. The method of claim 51, wherein the given type of the resource specified by the resource-identifying component is a processor and the time period is a number of days.

54. The method of claim 51, wherein the given type of the resource specified by the resource-identifying component is a processor and the time period is a number of days, and wherein the resource-time value is the product of the resource-identifying component and the time component.

55. The method of claim 51, further comprising using the enabled quantity of the resource during operation of the computerized apparatus.

56. The method of claim 55, further comprising:
determining the expiration of the time period; and
disabling the enabled quantity of the resource upon determining the expiration of the time period.

57. The method of claim 44, wherein enabling comprises making the quantity of the resource available to be placed into use, the method further comprising placing at least a portion of the enabled quantity of the resource into service for a specified time period.

58. The method of claim 57, further comprising:
determining the expiration of the time period; and
disabling at least the portion of the enabled quantity of the resource upon determining the expiration of the time period.

59. A method for enabling resources on a computerized apparatus, comprising:
initiating an initial program load (IPL) of the computerized apparatus;
during the IPL, determining a presence of a valid copy of vital product data identifying the computerized apparatus, wherein the valid copy is located on a secure write protected medium;
receiving an enablement code;
verifying the enablement code with respect to the vital product data; and
in response to verifying the enablement code, enabling a quantity of the resources.

60. The method of claim 59, wherein the enablement code comprises a resource identifier.

61. The method of claim 59, further comprising completing the IPL only if the presence of the valid copy is determined.

62. The method of claim 59, wherein the quantity of resources is specified in the enablement code.

63. The method of claim 59, wherein the enablement code is unique to the computerized apparatus.

64. The method of claim 59, wherein the quantity of the resources are enabled with a time restriction on use.
